(19) United States
(12) Patent Application Publication
(10) Pub. No.: US 2007/0083903 A1
(43) Pub. Date: Apr. 12, 2007

(54) Audio/video system for a notebook computer

(76) Inventors: Tai-Shing Wan, Kueishan Hsiang (TW); Ching-Hwa Yang, Sanhsia Town (TW)

Correspondence Address: RABIN & Berdo, PC, 1101 14TH STREET, NW, SUITE 500, WASHINGTON, DC, 20005, US

(21) Appl. No.: 11/325,470

(22) Filed: Jan. 5, 2006

(30) Foreign Application Priority Data
Oct. 6, 2005 (TW) 94134989

(51) Int. Cl. H04N 7/173; H04N 7/16

(52) U.S. Cl. 725/100; 725/131; 725/139

(57) ABSTRACT

An audio/video system for use in a notebook computer. The notebook computer with the audio/video system, without loading any operating system, can operate for users to watch television or video, as well as writing these programs to a storage device, such as a recordable compact disk. In one embodiment, circuits for processing audio/video signals in the audio/video system are integrated into a single chip for processing signals from analog television, digital television, and other video sources. In addition to the integration, appropriate and corresponding power management is provided to achieve lower energy consumption during the notebook computer operating for watching or copying of television programs or video.

This application claims the benefit of Taiwan application Serial No. 94134989, filed Oct. 6, 2005, the subject matter of which is incorporated herein by reference.

### BACKGROUND OF THE INVENTION

1. Field of the Invention

The invention relates in general to a computer system, and more particularly to a notebook computer and a system integration circuit for television functionality thereof.

2. Description of the Related Art

Currently, desktop computer systems can be designed for users to watch television programs and record them with a hard disk drive or writing them to a recordable compact disk in real time. However, such design should be based on a compact operating system, such as Linux, since computing resources and heavy tasks are required for performing such functionality. When an operating system controls the computer system for users to watch television programs in real time, the central processing unit of the computer system performs complicated instructions corresponding to displaying television programs. The computer system consumes more power than normal usage. In particular, copying the video data of the television programs to the hard disk drive or writing them to a recordable compact disk requires more corresponding circuitry to operate and associated software to be executed. Such scenario results in higher energy consumption.

Regarding a mobile computer system, such as a notebook computer, to be configured according to above design, the notebook computer, if only powered by batteries, can only operate a relatively reduced time for users to watch television programs in real time. In order to watch more television programs, users have to inconveniently change the batteries, if the batteries' energy is used up. Accordingly, it is desirable to implement the functionality in a notebook computer for users to watch television programs or video in real time, with reduced power consumption for displaying or copying corresponding video data, such that the notebook computer, if only powered by batteries, can operate longer.

### SUMMARY OF THE INVENTION

It is therefore an object of the invention to provide an audio/video system for use in a notebook computer so that the notebook computer, without loading any operating system, can operate for users to watch television or video in real time, as well as writing television program or video data to a storage device, such as a recordable compact disk.

The invention achieves the above-identified object by providing an audio/video system for a notebook computer, wherein the notebook computer includes a display device, a sound reproducing device, and a storage device. The audio/video system includes an analog tuner, a digital tuner, and an audio/video processing unit. The analog tuner, coupled to an analog television signal, is used for generating a first audio/video signal according to the analog television signal. The digital tuner, coupled to a digital television signal, is used for generating a second audio/video signal according to the digital television signal. The audio/video processing unit is employed for receiving the first audio/video signal, the second audio/video signal, and a third audio/video signal. When the notebook computer does not start up with an operating system, the audio/video system drives the display device, the sound reproducing device, and the storage device according to the first audio/video signal, the second audio/video signal, and the third audio/video signal. In one embodiment, the audio/video processing unit includes an audio/video driving unit and a computer signal converting unit. The audio/video driving unit is used for driving the display device and the sound reproducing device according to the first audio/video signal, the second audio/video signal, and the third audio/video signal, and for converting the first audio/video signal and the third audio/video signal into a digital audio/video signal. The computer signal converting unit is used for converting the digital audio/video signal and the second audio/video signal into audio/video writing data and for driving the storage device to writing the audio/video writing data to the storage device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram illustrating a notebook computer according to a preferred embodiment of the invention.

FIG. 2 shows an example of an audio/video system according to the invention.

FIG. 3 shows another example of an audio/video system according to the invention.

FIG. 4 shows one example of an audio/video system according to the invention.

### DETAILED DESCRIPTION OF THE INVENTION

The invention provides an audio/video system for use in a mobile computer system, such as a notebook computer, so that the notebook computer, without loading any operating system, can operate for users to watch television or video, as well as writing these programs to a storage device, for example, an optical disk by an optical disk writer. In one embodiment, circuits for processing audio/video signals in the audio/video system are integrated into a single chip for processing signals from analog television, digital television, and other video sources. In addition to the integration, appropriate and corresponding power management is provided to achieve lower power consumption during the notebook computer operating for watching or copying of television programs or video.

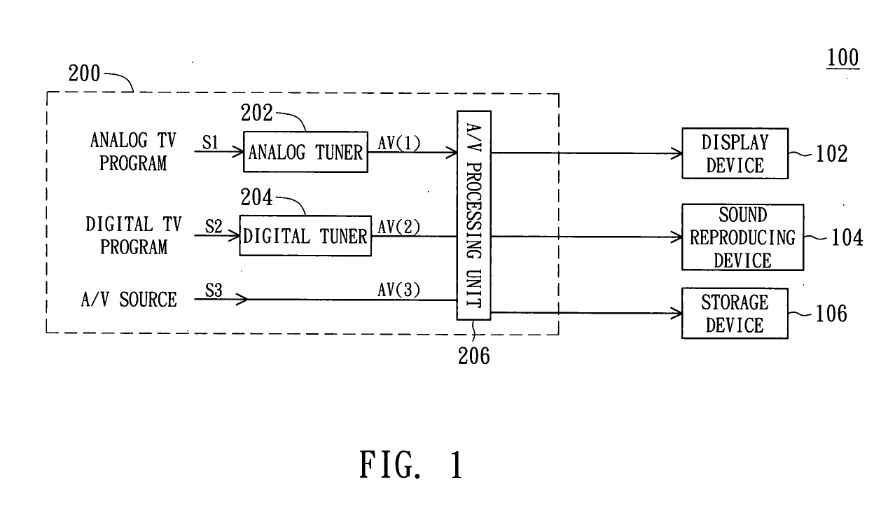

Referring to FIG. 1, a notebook computer according to a preferred embodiment of the invention is shown in block diagram form. An audio/video system 200 is for use in a notebook computer 100. The notebook computer 100 includes a display device 102, a sound reproducing device 104, and a storage device 106. As an example, the display device 102 is a liquid crystal display (LCD). The sound reproducing device 104 can be speakers and associated driving circuitry equipped in the notebook computer 100, where the associated driving circuitry can be, for example, an amplifier and a codec compliant with Audio Codec '97 (AC'97) specification by Intel. The storage device 106 can be a hard disk drive or an optical disk writer for optical disks, such as CD-R, CD-RW, DVD+R, DVD-R, DVD+RW, and/or DVD-RW, built in the notebook computer 100. In this embodiment, the storage device 106 is used for storing video data of a television program or a video source and thus any type of storage devices, either internal or external, can be suitable.

The audio/video system 200 further includes an analog tuner 202, a digital tuner 204, and an audio/video processing unit 206. The audio/video processing unit 206, for example, is a processor for performing audio/video demodulation and MPEG coding/decoding, and may be implemented by integrating an audio/video modulator and an MPEG codec. The analog tuner 202 is used for selecting a channel signal for an analog television program S1, converting the analog television program S1 into a first audio/video signal, hereinafter AV(1) signal, and outputting the AV(1) signal to the audio/video processing unit 206. The AV(1) signal, for example, includes a composite video broadcast signal (CVBS) and a second sound IF (SSIF) signal. The analog television program S1 is a radio frequency (RF) signal compliant with NTSC or PAL standard, for example. The digital tuner 204 is used for selecting a channel signal for a digital television program S2, converting the digital television program S2 into a second audio/video signal, hereinafter AV(2) signal, and outputting the AV(2) signal to the audio/video processing unit 206. The AV(2) signal, for example, is compliant with MPEG-2 transform stream standard.

In addition to the AV(1) signal and the AV(2) signal, the audio/video processing unit 206 can further receives an audio/video source S3, for example, an external audio/video source from a DVDNCD player or video game device, such as Play Station 2 by Sony. The audio/video source S3 received by the audio/video processing unit 206 is designated as a third audio/video signal, hereinafter AV(3) signal. The audio/video processing unit 206 drives the display device 102 and the sound reproducing device 104 or the storage device 106, or drives the display device 102, the sound reproducing device 104, and the storage device 106 at the same time, according to the AV(1) signal, the AV(2) signal, and the AV(3) signal.

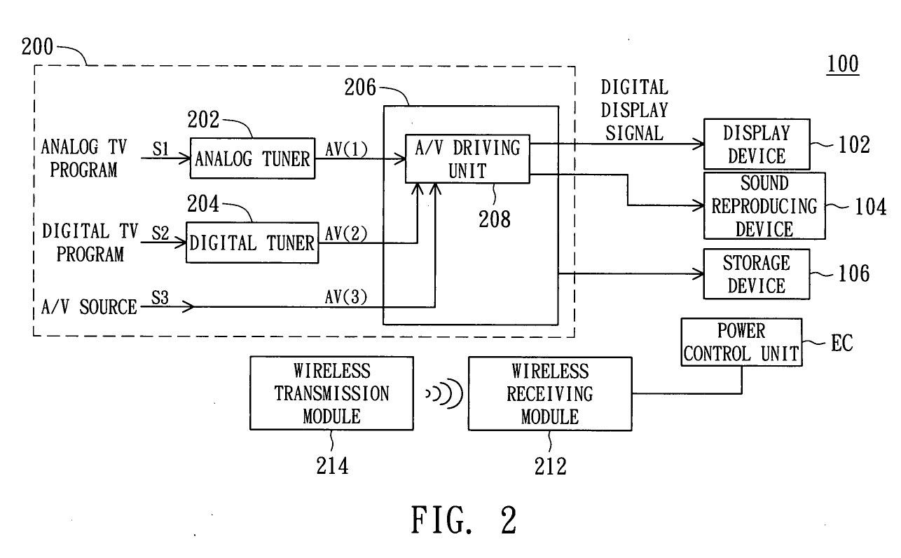

FIG. 2 shows an example of an audio/video system according to the invention. The audio/video system 200 further includes a power control unit, a wireless receiving module 212, and a wireless transmission module 214. In FIG. 2, the power control unit is implemented by an embedded IC, as indicated by EC, for example. The power control unit EC and the wireless receiving module 212 are disposed in the notebook computer 100. The power control unit EC is used for management of power supply in the notebook computer 100, wherein the power management includes power management of the audio/video system 200. The power control unit EC is coupled to the wireless receiving module 212. The wireless transmission module 214 is an infrared remote controller, for example. The wireless receiving module 212, such as an infrared receiving module, corresponds to the wireless transmission module 214 and receives signals indicating commands from the wireless transmission module 214. The audio/video processing unit 206 further includes an audio/video driving unit 208 for driving the display device 102 and the sound reproducing device 104 according to one of the AV(1) signal, AV(2) signal, or AV(3) signal.

First, the operation of the audio/video system 200 is illustrated with a scenario that the notebook computer 100, without starting up with an operating system, for example, Microsoft Windows XP or Linux, is used to display an analog television program S1, a digital television program S2, or an audio/video source S3. The wireless transmission module 214 is used to activate the audio/video system 200, for example, to select the analog television program S1. The power control unit EC, then, starts the analog tuner 202, audio/video processing unit 206, display device 102, and sound reproducing device 104. The audio/video driving unit 208 is used to convert the video component of the AV(1) signal outputted by the analog tuner 202 into a digital display signal, which can be received or accepted by the display device 102. That is, the digital display signal is the CVBS if the AV(1) signal includes the CVBS and SSIF signal. As an example, the audio/video driving unit 208 includes a video processing device and a converter (both not shown). The video processing device converts the AV(1) signal into a digital audio/video signal TS, which is compliant with MPEG-2 Transport stream standard. The digital audio/video signal TS is converted into a non-interlaced signal, that is, the digital display signal, and is outputted to the display device 102. The display device 102 displays video according to the non-interlaced signal. The audio component of the digital audio/video signal TS, after processed, is transferred to and reproduced by the sound reproducing device 104. In this way, the notebook computer 100 can display an analog television program S1, without starting up with the operating system while energy can be saved because only necessary components for facilitating this functionality need to be powered, for example the audio/video processing unit 206, power control unit EC, analog tuner 202, display device 102, and sound reproducing device 104. For example, the power control unit EC controls the provision of voltages for operation of these components.

In addition, the operation of displaying a digital television program S2 or an audio/video source S3 is similar to the above. For example, when a user would like to watch a digital television program S2, the user may use the wireless transmission module 214 to select the digital television program S2. The audio/video driving unit 208, then, receives the AV(2) signal outputted from the digital tuner 204. Since the AV(2) signal is compliant with the standard of the TS signal, the audio/video processing unit 206 directly converts the AV(2) signal into a signal in a format which can drive the display device 102 and drives the sound reproducing device 104 to reproduce sound. For example, the AV(2) signal drives the display device 102 through the converter mentioned above. With respect to power management, only the audio/video driving unit 208, power control unit EC, digital tuner 204, display device 102, and sound reproducing device 104 are powered. For example, the power control unit EC controls the provision of voltages for operation of these components.

Finally, the operation of displaying an audio/video source S3 is similar to the above, except for not using the analog tuner 202 and digital tuner 204. The audio/video driving unit 208 receives an audio/video signal, that is AV(3), from the audio/video source S3 and drives the display device 102 and sound reproducing device 104 according to the AV(3) signal. As discussed above, users can watch the analog television program S1, the digital television program S2, or the audio/video source S3, without starts up the notebook computer 100 with the operating system. Further, all of some related circuits of the audio/video processing unit 206, for example, the audio/video driving unit 208, the video processing device, and the converter, can be implemented and integrated into a single IC to save chip area and reduce power consumption.

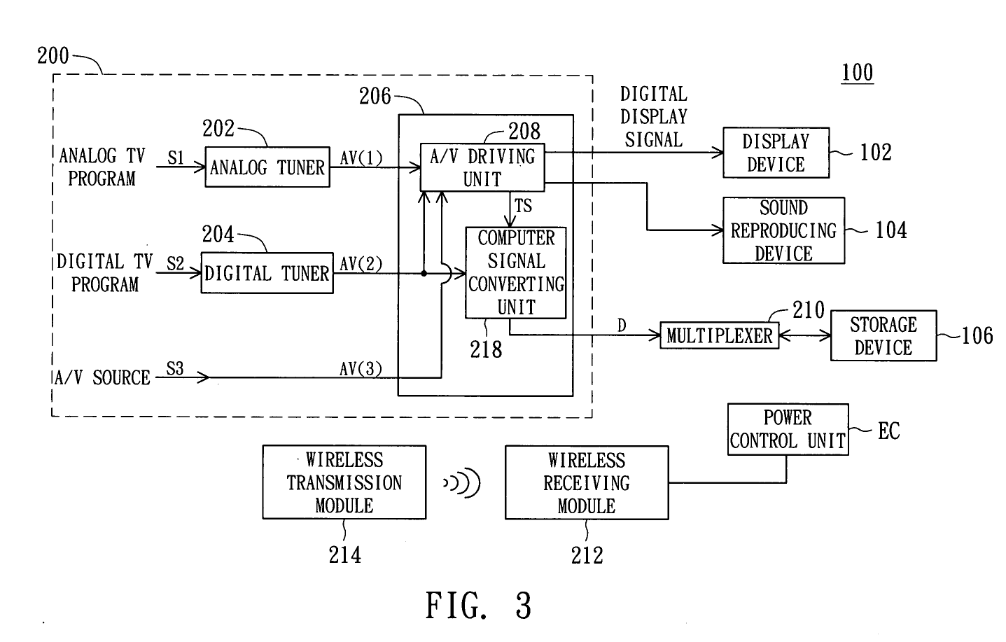

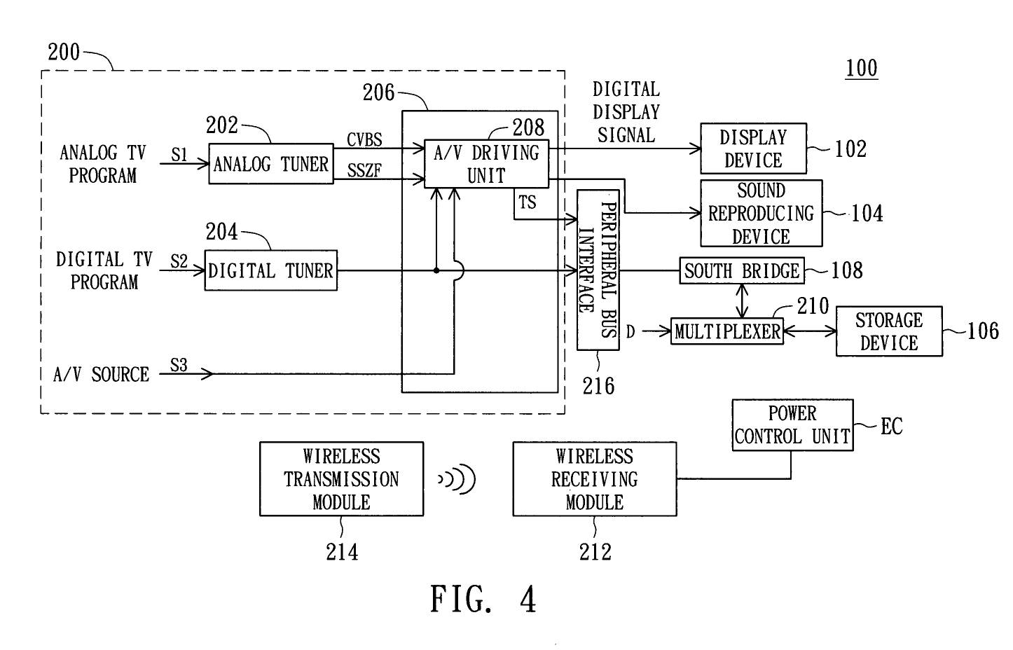

FIG. 3 shows another example of an audio/video system according to the invention. When it is desired to record the analog television program S1, digital television program S2, or audio/video source S3 to the storage device 106, for example, recording it with a hard disk drive or an optical disk writer, the audio/video processing unit 206 is further employed to convert the AV(1) signal, AV(2) signal, or AV(3) signal into a data bit stream that can be received by the hard disk drive or the optical disk writer. In this example, the audio/video system 200 further includes a multiplexer 210 and the audio/video processing unit 206 further includes a computer signal converting unit 218. The computer signal converting unit 218 converts the digital audio/video signal TS or the AV(2) signal into audio/video writing data, indicated by D, for example, the data bit stream mentioned above. The audio/video writing data, D, can be transferred to the multiplexer 210 through an interface, such as integrated drive electronics (IDE) interface. The multiplexer 210 is coupled to the optical disk writer or hard disk drive selectively for data transmission. The multiplexer 210 is also coupled to a south bridge of the notebook computer 100 (shown in FIG. 4) for facilitating corresponding signal transmission between the storage device 106 and the south bridge when the notebook computer 100 operates with the operating system. In this way, real-time recording of the analog television program S1, digital television program S2, or audio/video source S3 can be performed without starting up the notebook computer 100 with the operating system. In addition, energy of batteries of the notebook computer 100 is saved because only the necessary components, for example, the audio/video processing unit 206, power control unit EC, analog tuner 202, digital tuner 204, multiplexer 210, and storage device 106, are needed to be powered to achieve such functionality. For displaying video of a video source and recording them at the same time, it is only necessary to activate the audio/video driving unit 208 and the computer signal converting unit 218.

Further, a scenario is described where the notebook computer 100, operating with the operating system, displays or records an analog television program S1, a digital television program S2, and an audio/video source S3. Referring to FIG. 4, one example of an audio/video system according to the invention. In this example, the audio/video system 200 further includes a peripheral bus interface 216. The notebook computer 100 includes a south bridge 108. For displaying or recording the analog television program S1 or audio/video source S3, the audio/video processing unit 206 converts the AV(1) signal or AV(3) signal into a digital audio/video signal TS, for example, compliant with MPEG-2 transport stream standard, or a digital video signal and a digital audio signal in other format. The digital audio/video signal TS (or the other digital video and audio signals) is transferred to the south bridge 108 of the notebook computer 100 via the peripheral bus interface 216, such as USB, PCI, or IEEE1394, and is then provided to a corresponding program executed by the operating system to display, or to record onto the storage device 106 via the multiplexer 210.

When displaying or recording the digital television program S2, the audio/video processing unit 206 directly transfers the AV(2) signal outputted by the digital tuner 204 to the computer system for the corresponding program executed by the operating system to display or record onto the storage device 106.

The audio/video system disclosed in the above embodiments can be used for displaying television programs or video of a video source or recording video data of them, without loading of the operating system. With the integration of related circuits into a signal chip and appropriate power management, the notebook computer results in a reduced power consumption during displaying or recording.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio/video system for a notebook computer, the notebook computer comprising a display device, a sound reproducing device, and a storage device, the audio/video system comprising:
an analog tuner, coupled to an analog television signal, for generating a first audio/video signal according to the analog television signal;
a digital tuner, coupled to a digital television signal, for generating a second audio/video signal according to the digital television signal;
an audio/video processing unit for receiving the first audio/video signal, the second audio/video signal, and a third audio/video signal, the audio/video processing unit comprising:
an audio/video driving unit for driving the display device and the sound reproducing device according to the first audio/video signal, the second audio/video signal, and the third audio/video signal, and for converting the first audio/video signal and the third audio/video signal into a digital audio/video signal; and
a computer signal converting unit for converting the digital audio/video signal and the second audio/video signal into audio/video writing data, and for driving the storage device to writing the audio/video writing data to the storage device;
wherein when the notebook computer does not start up with an operating system, the audio/video system drives the display device, the sound reproducing device, and the storage device according to the first audio/video signal, the second audio/video signal, and the third audio/video signal.

2. The audio/video system according to claim 1, further comprising:
a peripheral bus interface for transferring the digital audio/video signal and the second audio/video signal to a south bridge of the notebook computer.

3. The audio/video system according to claim 2, wherein the peripheral bus interface is compliant with universal serial bus standard.

4. The audio/video system according to claim 1, further comprising:
a multiplexer for signal transmission among the computer signal converting unit, the storage device, and a south bridge of the notebook computer.

5. The audio/video system according to claim 4, wherein the computer signal converting unit is coupled to the multiplexer via an integrated drive electronics (IDE) interface.

6. The audio/video system according to claim 4, wherein the audio/video processing unit is further used for controlling the analog tuner, the digital tuner, the display device, the sound reproducing device, and the storage device.

7. The audio/video system according to claim 1, further comprising a power control unit for power management of the audio/video system.

8. The audio/video system according to claim 7, further comprising:
a wireless receiving module coupled to the power control unit; and
a wireless transmission module for wireless transmission with the wireless receiving module and for activating the audio/video system.

9. The audio/video system according to claim 7, wherein when the notebook computer does not start up with an operating system and the audio/video system drives the display device and the sound reproducing device according to the first audio/video signal, the second audio/video signal, and the third audio/video signal, the power control unit controls the provision of voltages for operation of the audio/video processing unit, the analog tuner, the display device, the sound reproducing device, and the wireless receiving module.

10. The audio/video system according to claim 7, wherein when the notebook computer does not start up with an operating system and the audio/video system drives the storage device according to the first audio/video signal, the second audio/video signal, and the third audio/video signal, the power control unit controls the provision of voltages for operation of the audio/video processing unit, the analog tuner, the storage device, and the wireless receiving module.
